(19) United States
(12) Patent Application Publication
(10) Pub. No.: US 2010/0135421 A1
(43) Pub. Date: Jun. 3, 2010

(54) APPARATUS AND METHOD FOR REDUCING PEAK TO AVERAGE POWER RATION IN ORTHOGONAL FREQUENCY DIVISION MULTIPLEXING SYSTEM

(75) Inventors: Jae-Ho Jung, Daejeon (KR); Kwang Chun Lee, Daejeon (KR); Sung Bin Im, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignees: Electronics and Telecommunications Research Institute, Daejeon (KR); Soongsil University Industry & Academy Collaboration Foundation, Seoul (KR)

(21) Appl. No.: 12/517,925

(22) PCT Filed: Nov. 28, 2007
(86) PCT No.: PCT/KR2007/006055

§ 371 Date: Nov. 3, 2009

(30) Foreign Application Priority Data
Dec. 5, 2006 (KR) 10-2006-0122026
Jun. 29, 2007 (KR) 10-2007-0065075

(51) Int. Cl. H04L 27/28

(52) U.S. Cl. 375/260

(57) ABSTRACT

An apparatus for reducing PAPR (Peack to Average Power Ratio) in an OFDM (Orthogonal Frequency Division Multiplexing) system includes: an IFFT (Inverse Fast Fourier Transform) unit for performing an IFFT on an input data stream modulated using a specific constellation to generate time-domain signals; a time-domain clipping unit for performing a time-domain clipping on the time-domain signals at a clipping level determined by characteristics of the time-domain signals; an FFT (Fast Fourier Transform) unit for performing an FFT on the clipped time-domain signals to generate frequency-domain signals; and a frequency-domain clipping unit for performing a frequency-domain clipping on the frequency-domain signals. The time-domain clipping reduces in the OFDM system, and the frequency-domain clipping reduces distortions generated by the time-domain clipping.

### TECHNICAL FIELD

The present invention relates to an OFDM (Orthogonal Frequency Division Multiplexing) system; and, more particularly, to an apparatus and a method for reducing PAPR (Peak to Average Power Ratio) in an OFDM system.

This work was supported by the IT R&D program of MIC/IITA. [2005-S-016-02, Development of Multimode Base Station]

### BACKGROUND ART

Though an OFDM communications system has a lot of merits compared to a single carrier system, it has a drawback that complex-Gaussian distributed output samples generate high PAPR. In order to prevent non-linear distortions due to a high peak value of such a signal, a transmitter is generally required to use a considerable amount of back-off, which results in a low output of an amplifier and also reduces communications efficiency. In other words, a conventional code division multiplexing techniques have used a back-off method for expanding a linear region in a transmitter. However, it is difficult to employ the back-off method in the OFDM system because the high PAPR makes it difficult to guarantee the linearity of a transmit power amplifier.

The high PAPR is generated mainly because phases of symbols are arranged in parallel at subchannels to thereby generate a maximum value in a time-domain signal. In order to solve this problem, a variety of PAPR reduction techniques using a data scrambling, a phase optimization or the like has been proposed.

The PAPR reduction techniques employed in the conventional OFDM transmitter can reduce the PAPR by applying a PAPR reduction technique in a frequency domain. However, since many pieces of side information are required to be transmitted, there is a drawback that architecture of a receiver needs to be modified.

### DISCLOSURE OF INVENTION

### Technical Problem

It is, therefore, an object of the present invention to provide an apparatus and a method for reducing PAPR in an OFDM system.

### Technical Solution

In accordance with one aspect of the present invention, there is provided an apparatus for reducing PAPR (Peack to Average Power Ratio) in an OFDM (Orthogonal Frequency Division Multiplexing) system, including:

an IFFT (Inverse Fast Fourier Transform) unit for performing an IFFT on an input data stream modulated using a specific constellation to generate time-domain signals;

a time-domain clipping unit for performing a time-domain clipping on the time-domain signals at a clipping level determined by characteristics of the time-domain signals to reduce PAPR in the OFDM system;

an FFT (Fast Fourier Transform) unit for performing an FFT on the clipped time-domain signals to generate frequency-domain signals; and

a frequency-domain clipping unit for performing a frequency-domain clipping on the frequency-domain signals to reduce distortions generated by the time-domain clipping.

In accordance with another aspect of the present invention, there is provided a method for reducing PAPR (Peak to Average Power Ratio) in an OFDM (Orthogonal Frequency Division Multiplexing) system, the method including the steps of:

(a) performing an IFFT on an input data stream modulated using a specific constellation to generate a time-domain signals;

(b) peforming time-domain clipping on the generated time-domain signals at a specific clipping level to reduce PAPR in the OFDM system;

(c) performing an FFT on the clipped time-domain signals to generate frequency-domain signals; and

(d) performing a frequency-domain clipping on the generated frequency-domain signals to reduce distortions generated by the time-domain clipping.

### Advantageous Effects

In accordance with the method for reducing PAPR in an OFDM system of the present invention, PAPR of transmit signals is reduced by a transmit signal processing using a new PAPR reduction technique capable of reducing a time consumption or a computational complexity for finding an optimal solution, on the assumption that a PAPR reduction is a matter of optimization for minimizing a peak value while satisfying a restriction with respect to a given constellation error or range. Thus, conventional receiver architecture can be used without modifications, and also reduced computation amount and simple implementation can be achieved.

### BRIEF DESCRIPTION OF THE DRAWINGS

The above and other objects and features of the present invention will become apparent from the following description of embodiments given in conjunction with the accompanying drawings, in which:

FIG. 1 is a schematic configuration view showing a transmitter using a PAPR reduction technique in an OFDM system;

FIG. 2 is a schematic configuration view showing an apparatus for reducing PAPR in an OFDM system in accordance with an embodiment of the present invention;

FIG. 3 is a flowchart illustrating a method for reducing PAPR in an OFDM system in accordance with an embodiment of the present invention; and

FIGS. 4 to 9 are graphs showing experimental results of transmit signal processing procedures in an OFDM system in accordance with the present invention.

### BEST MODE FOR CARRYING OUT THE INVENTION

Hereinafter, embodiments of the present invention will be described in detail with reference to the accompanying drawings. Like reference numerals will be given to like parts having substantially the same functions, and redundant description thereof will be omitted in the specification and the accompanying drawings.

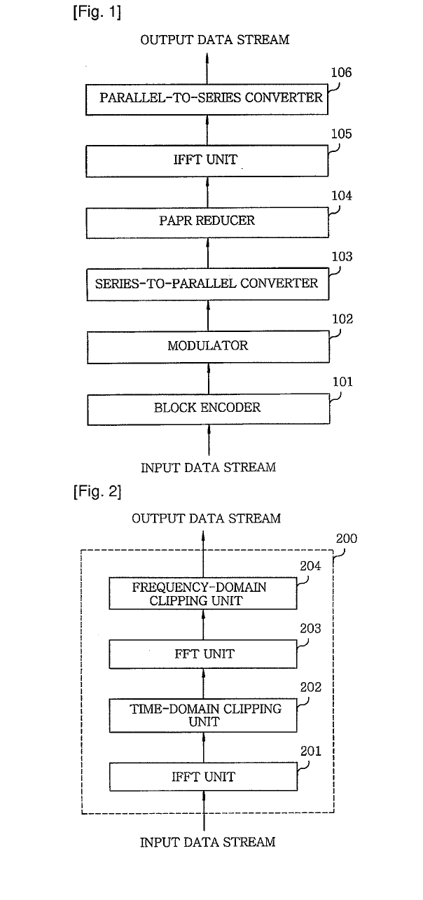

FIG. 1 is a schematic configuration view showing an OFDM transmitter using a PAPR reduction technique. The OFDM transmitter includes a block encoder 101, a modulator 102, a series-to-parallel converter 103, a PAPR reducer 104, an IFFT (Inverse Fast Fourier Transform) unit 105, and a parallel-to-series converter 106.

As shown in FIG. 1, an input data stream is block-encoded in the block encoder 101, and then modulated in the modulator 102. After that, PAPR is reduced in the PAPR reducer 104.

FIG. 2 is a schematic configuration view showing an apparatus for reducing PAPR in an OFDM system in accordance with an embodiment of the present invention. In FIG. 2, an apparatus 200 for reducing PAPR, an input data stream and an output data stream correspond to the PAPR reducer 104, the input and the output of the PAPR reducer 104 in FIG. 1, respectively.

In the apparatus 200 in FIG. 2, OFDM symbols to be transmitted are oversampled at an oversampling rate L and an IFFT is then performed on the oversampled OFDM symbols in an IFFT unit 201 to thereby transform them into a time-domain signal. In order to reduce PAPR, a time-domain clipping is performed on the time-domain signals at a specific clipping level in a time-domain clipping unit 202, and then the clipped time-domain signals are transformed again into frequency-domain signals in an FFT (Fast Fourier Transform) unit 203. Among the OFDM symbols of the transformed frequency-domain signals, a frequency-domain clipping unit 204 performs a frequency-domain clipping on OFDM symbols whose constellation distortions are out of an allowable error range δ to reduce distortions in the OFDM symbols. After that, an IFFT is performed on the frequency-domain OFDM symbols in a not shown IFFT unit (the IFFT unit 105 in FIG. 1), and then the transformed symbols are transmitted.

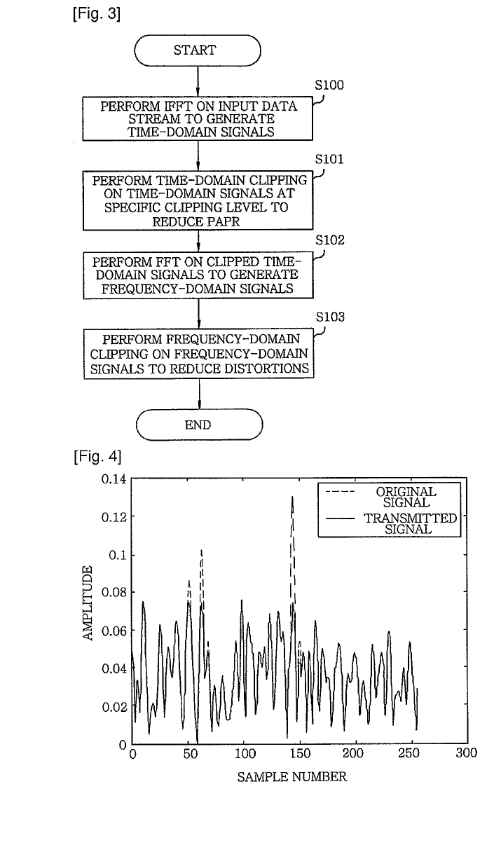

FIG. 3 is a flowchart showing a method for reducing PAPR in an OFDM system in accordance with an embodiment of the present invention.

In accordance with the method of the present invention, first, an IFFT is performed on an input data stream to generate time-domain signals (step S100). Here, OFDM symbols of the input data stream are oversampled at a specific oversampling rate before performing the IFFT.

A time-domain clipping is performed on the time-domain signals generated by the IFFT at a specific clipping level to reduce PAPR (step S101). At this time, the clipping level is a desired PAPR and determined by characteristics of the time-domain signals.

After an FFT is performed on the clipped time-domain signals (step S102), the signals are clipped or filtered in a frequency domain to thereby reduce signal distortions generated by the time-domain clipping (step S103). To be specific, the frequency-domain signals are clipped to restrict constellation error components due to in-band distortions generated by the time-domain clipping in the step S101 within an allowable error range determined by EVM (Error Vector Magnitude) of a constellation and “0”s are inserted in the frequency domain to eliminate out-of-band distortions generated by the time-domain clipping in the step S101.

After that, an IFFT is performed on the signal clipped or filtered in the frequency domain to regenerate a time domain transmit signal, and the regenerated time domain transmit signal is transmitted.

In order to achieve performance improvement, the steps S100 to S103 may be iterated specific number of times by using the clipped frequency-domain signals in the step S103 as the input data stream in the step S100.

In accordance with the method for reducing PAPR of the present invention, on the assumption that a PAPR reduction is a matter of optimization, a clipping based suboptimization method is adopted to overcome a high computational complexity pf a conventional optimization solution. Therefore, reduced computation amount and simple implementation can be achieved. Moreover, modification of receiver architecture is not required.

A detailed description of the method for reducing PAPR of the present invention will be made using Equations below. In an OFDM signal, frequency spacing between adjacent subcarriers is expressed as 1/T. The OFDM signal is a sum of the N number of independent QAM (Quadrature Amplitude Modulation) signals of subchannels having an identical bandwidth. Here, T denotes an interval between OFDM symbols in a time domain. An input data stream is mapped to M-QAM (M-ary QAM) symbols to form a complex symbol vector c (

c=[c₀ . . . c_{N-1}]^{T} ε C^{N}

). The complex symbol vector is again transformed into a discrete time signal x (

x=[x₀ . . . x_{N-1}]^{T}

) by an IFFT process of Equation 1.

MathFigure 1

$${x}_{n} = \frac{1}{\sqrt{N}} {\sum }_{k = 0}^{N - 1} {c}_{k} {e}^{j 2 π kn / N} \qquad [ Math . 1 ]$$

In a real system, an OFDM symbol c is oversampled by L times and an IFFT is performed on the oversampled OFDM symbol to generate a discrete time signal x (

x ε C^{NL}

). For a given constellation c (

c ε C^{N}

) of OFDM symbols, a constellation

\tilde{c}

(

\tilde{c} ε C^{N}

) satisfying a restriction of Equation 2 with respect to a mean EVM (hereinafter, referred to as “EVM restriction” can be considered.

MathFigure 2

$$\sqrt{\frac{\frac{1}{D} {\sum }_{i = {i}_{1}}^{{i}_{D}} {\vert {\tilde{c}}_{i} - {c}_{i} \vert}^{2}}{{P}_{0}}} \leq {EVM}_{max} \qquad [ Math . 2 ]$$

In Equation 2, a normalization factor PO denotes a mean power used in a BPSK (Binary Phase Shift Keying), QAM, 16QAM or 64QAM constellation, and D denotes the number of subcarriers for transmitting OFDM symbols. EVMmax is determined by a complexity of a constellation, performance of an error correction code, and a data transfer rate. A receiver can accurately demodulate data when a transmit signal satisfies the EVM restriction. For a simplicity of expression, a constellation error coefficient ε (

ε ∈ᵣR

) is defined as Equation 3.

MathFigure 3

### [Math.3]

ε=EVMₘₐₓ \sqrt{DP₀}

Assuming that a constellation c (

c ε C^{N}

) is one of specific OFDM constellations, minimization of PAPR in the present invention is a matter of finding a constellation minimizing PAPR among constellations

\tilde{c}

(

\tilde{c} ε C^{N}

) satisfying the EVM restriction for the given constellation c. That is, PAPR is optimized while minimizing a time-domain peak value and maintaining a mean transmit power of data within a limited range. Accordingly, minimization of PAPR is a matter of a convex optimization problem known as a SOCP (Second Order Cone Program), and can be expressed as Equation 4.

MathFigure 4

### [Math.4]

minimize p

subject to ||\tilde{x}ᵢ||≦p, i=1, . . . NL

\tilde{x}=IFFT₁(\tilde{c})

||S(\tilde{c}−c)||≦ε

Re [symbol] S\tilde{c}.Sc [symbol] ≧||Sc||²−ε²/2

in variables p ε R, \tilde{c} ε C^{N}, \tilde{x} ε C^{NL}

In Equation 4, a matrix S is a diagonal matrix. Sii is set to one in case where an ith subcarrier transmits information, and otherwise, set to zero. Subcarriers out of a given band forcibly become zero by an oversampling IFFT. Equation 4 always has an optimal solution of

(p, \tilde{c}, \tilde{x})=(p*, c*, x*)

. The optimal solution can be obtained using conventional well-known algorithms. Since a method for obtaining a solution of Equation 4 needs to use iterative operation, complexity of the algorithm for obtaining the solution of Equation 4 is proportional to the number of times of repetitive computation.

For a given constellation c of OFDM symbols, an optimal constellation

\tilde{c}

satisfying Equation 4 minimizes PAPR while satisfying the EVM restriction, and thus, it is not required to transmit side information. Accordingly, a conventional receiver can be used without modifications and signals can be demodulated without errors when there is no background noise.

In accordance with the present invention, a suboptimization method for minimizing PAPR while reducing computational complexity is used in solving a PAPR reduction problem expressed as Equation 4. Though a PAPR provided by a suboptimal reduction technique is higher than an optimally minimum PAPR obtained from Equation 4, it is still lower than PAPR of an original signal. Further, the suboptimal reduction technique is relatively simpler than a method for finding an optimal solution, thereby reducing computational complexity. Here, a constellation error Δ is defined as Equation 5.

MathFigure 5

### [Math.5]

Δ=\tilde{c}−c

Relationship between an original time-domain signal x and a signal

\tilde{x}

having a reduced PAPR can be expressed as Equation 6.

MathFigure 6

### [Math.6]

IFFT(Δ)=\tilde{x}−x

As shown in Equation 6, an FFT of an error between the time-domain signal

\tilde{x}
having a reduced PAPR and the original signal x becomes the constellation error Δ. Here, it is a matter to be first solved to find the time-domain signal
\tilde{x}
having the reduced PAPR. The easiest method for reducing PAPR is to clip peak values of the original signal x to meet a specific PAPR. However, in this method, clipping causes in-band and out-of-band distortions of a signal and thus, results in a degradation of a bit error rate and a spectral regrowth. In order to solve the above problems and obtain a constellation error Δ satisfying the EVM restriction, an FFT is performed on

\tilde{x}−x

and then, a constellation error
Δₖ
of a kth carrier component is scaled when it is out of the allowable EVM range Δ (i.e., in case

|Δₖ|>S

) so that
Δₖ
falls within an allowable EVM range δ. In other words, the error component (
Δₖ
) out of the allowable EVM range ε is clipped as in Equation 7.

MathFigure 7

$${\tilde{Δ}}_{k} = {Δ}_{k} \frac{δ}{\vert {Δ}_{k} \vert} \qquad [ Math . 7 ]$$

Such clipping is referred to as a frequency-domain clipping. Here, a new error component

\tilde{Δ}

obtained through the above clipping satisfies a condition of Equation 8.

MathFigure 8

### [Math.8]

||S\tilde{Δ}||≧ε

In this case, a receiver can demodulate signals without error if there exists no background noise.

FIGS. 4 to 9 illustrate simulation results in accordance with the present invention.

FIG. 4 shows a comparison result between amplitudes of a time-domain transmit signal xt and an original signal x in case of using 4QAM. In this experiment, data was modulated with 4QAM and the number of carriers transmitting modulated data was sixty four among total sixty four carriers. In general, if a signal is clipped, peak values have an identical value. However, though a signal is clipped in the method of the present invention, peak values of a time-domain waveform are not uniform because the frequency-domain clipping using the allowable error range δ is performed so that an error signal lies within a decision boundary of a symbol in a frequency domain. Here, an allowable error range was set to a range corresponding to 20% of a minimum distance between symbols (i.e., δ=0.2). In FIG. 4, PAPR of the original signal x was 9.8 dB and PAPR of the transmit signal xₜ generated using a proposed method was 5.0 dB, which implies that there was an improvement of about 4.8 dB. Here, a clipping level of 5 dB was used.

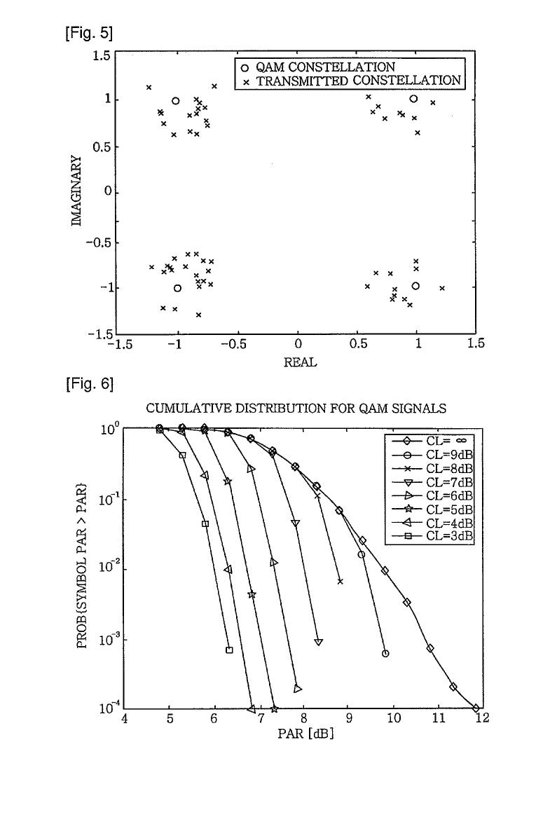

FIG. 5 shows a constellation of a 4QAM OFDM symbol used in a waveform of FIG. 4. In FIG. 5, circles and crosses represent a position of a QAM symbol and constellations thereof distorted within an allowable error range for transmission, respectively. In the case of transmission without noise, a bit error rate becomes zero because a distorted symbol is within the decision boundary.

FIG. 6 shows a cumulative distribution of PAPR of a transmit signal xₜ, which was measured while varying a clipping level (CL) from 9 dB to 3 dB. In this experiment, data was modulated with QAM and the number of carriers transmitting modulated data was sixty four among total sixty four carriers. The cumulative distribution is defined Equation 9.

MathFigure 9

### [Math.9]

Cumulative Distribution=Prob(OFDM Symbol's PAR>PAR)

Here, an allowable error range δ was set to a range corresponding to 50% of a minimum distance between symbols (i.e., δ=0.5) and the number of times of iteration was only once. As shown in FIG. 6, it can be observed that, in case of using QAM, PAPR was improved with a decrease of the clipping level.

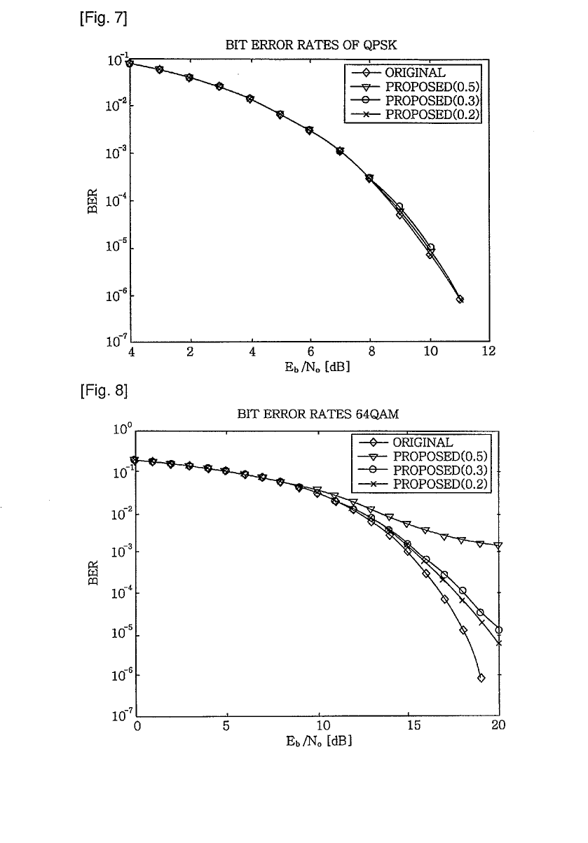

FIG. 7 shows a graph of bit error rate versus signal-to-noise ratio at an AWGN (Additive White Gaussian Noise) channel when an allowable error range δ was set to 50%, 30%, and 20% of a minimum distance between symbols. In this experiment, a clipping level was set to 7 dB and the number of times of iteration was limited to one. In case of using QAM, without any influence from a value of δ, the result shows similar bit error rates between an original signal and a signal having a PAPR reduced by using the proposed method. This denotes that the allowable error range δ does not exercise influence on a bit error rate because a decision boundary of a QAM symbol is broad.

On the contrary, in case of using 64QAM as shown in FIG. 8, an influence from a variation of an allowable error range δ does not appear at a low signal-to-noise ratio, whereas a bit error rate becomes worse as the allowable error range δ becomes larger when an influence of noise is small (i.e., at a high signal-to-noise ratio). The reason is that, constellation error components are added to reduce PAPR because a decision boundary becomes relatively smaller with an increase of a modulation level and the added constellation error components are influenced by even a small noise to thereby cause a bit error rate.

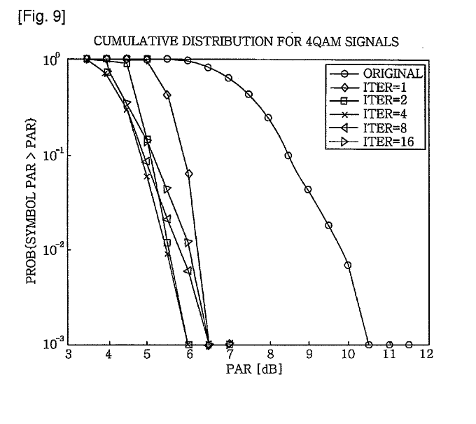

FIG. 9 shows a PAPR cumulative distribution of an original signal and of a result obtained by applying the number of times of iteration as 1, 2, 4, 8 and 16. In this experiment, data was modulated with 4QAM and applied clipping level was 3 dB. Further, an allowable error range δ was set to 20% of a minimum distance between symbols. As shown in FIG. 9, PAPR is remarkably improved at one time of iteration, but not so greatly improved after two times of iteration.

While the invention has been shown and described with respect to the embodiments, it will be understood by those skilled in the art that various changes and modification may be made without departing from the scope of the invention as defined in the following claims.

1. An apparatus for reducing PAPR (Peack to Average Power Ratio) in an OFDM (Orthogonal Frequency Division Multiplexing) system, comprising:
an IFFT (Inverse Fast Fourier Transform) unit for performing an IFFT on an input data stream modulated using a specific constellation to generate time-domain signals;
a time-domain clipping unit for performing a time-domain clipping on the time-domain signals at a clipping level determined by characteristics of the time-domain signals to reduce PAPR in the OFDM system;
an FFT (Fast Fourier Transform) unit for performing an FFT on the clipped time-domain signals to generate frequency-domain signals; and
a frequency-domain clipping unit for performing a frequency-domain clipping on the frequency-domain signals to reduce distortions generated by the time-domain clipping.

2. The apparatus of claim 1, wherein the IFFT unit oversamples OFDM symbols of the input data stream at a specific oversampling rate before performing the IFFT on the input data stream.

3. The apparatus of claim 1, wherein the frequency-domain clipping unit clips the frequency-domain signals to restrict constellation error components due to in-band distortions generated by the time-domain clipping within an allowable error range determined by EVM (Error Vector Magnitude) of the constellation and inserts “0”s in the frequency domain to eliminate out-of-band distortions generated by the time-domain clipping.

4. A method for reducing PAPR (Peak to Average Power Ratio) in an OFDM (Orthogonal Frequency Division Multiplexing) system, the method comprising the steps of:
(a) performing an IFFT on an input data stream modulated using a specific constellation to generate a time-domain signals;
(b) performing time-domain clipping on the generated time-domain signals at a specific clipping level to reduce PAPR in the OFDM system;
(c) performing an FFT on the clipped time-domain signals to generate frequency-domain signals; and
(d) performing a frequency-domain clipping on the generated frequency-domain signals to reduce distortions generated by the time-domain clipping.

5. The method of claim 4, wherein, in the step (a), OFDM symbols of the input data stream are oversampled at a specific oversampling rate before performing the IFFT on the input data stream.

6. The method of claim 4, wherein, in the step (b), the clipping level is determined by characteristics of the time-domain signals.

7. The method of claim 4, wherein, in the step (d), the frequency-domain signals are clipped to restrict constellation error components due to in-band distortions generated by the time-domain clipping within an allowable error range determined by EVM (Error Vector Magnitude) of the constellation and “0”s are inserted in the frequency domain to eliminate out-of-band distortions generated by the time-domain clipping.

8. The method of claim 4, wherein the steps (a) to (d) are iterated by using the clipped frequency-domain signals in the step (d) as the input data stream in the step (a).
